(19) United States
(12) Patent Application Publication
(10) Pub. No.: US 2026/0161895 A1
(43) Pub. Date: Jun. 11, 2026

(54) DATA PROCESSING METHOD, AND RELATED DEVICE

(71) Applicant: MASHANG CONSUMER FINANCE CO., LTD., Chongqing (CN)

(72) Inventor: Lebin LV, Chongqing (CN)

(21) Appl. No.: 19/092,808

(22) Filed: Mar. 27, 2025

(30) Foreign Application Priority Data
Dec. 5, 2024 (CN) 202411799599.X

(51) Int. Cl. G06F 40/35

(52) U.S. Cl. CPC G06F 40/35

(57) ABSTRACT

In a data processing method, a first dialog sample is obtained. The first dialog sample includes a first set of words. A first position of the first set of words in a dialog flow is determined to obtain a flow label of the first set of words. A second set of words in a library is determined based on the flow label of the first set of words. When a flow label of the second set of words matches the flow label of the first set of words, the second set of words with the first dialog sample is fused to obtain a second dialog sample.

### RELATED APPLICATION

The present application claims priority to Chinese Patent Application No. 202411799599.X filed on Dec. 5, 2024, which is hereby incorporated by reference in its entirety.

### FIELD OF THE TECHNOLOGY

This disclosure relates to the field of artificial intelligence (AI) technologies, including to a data processing method, a response sentence generating method, and related device.

### BACKGROUND OF THE DISCLOSURE

With an AI era embraces new changes, and larger models, more intelligent dialogs, and more knowledge storage begin to become pursued objectives for language model researchers. How to enable a language model to achieve smoother and more realistic dialogs also becomes a research focus. Before emergence of a large model, related chatbots used by various companies and enterprises primarily rely on methods such as intent recognition, a process canvas, and node flow configuration and are configured for online conversations and question-and-answer sessions. An entire dialog flow relies on a preset process canvas and a state management model, to determine subsequent phrasing based on an answer of a customer. Such a configuration manner is monotonous and not flexible enough. Consequently, an online real conversation is prone to an irrelevant answer and a lack of fluency.

### SUMMARY

This disclosure provides a data processing method, a response sentence generating method, and a related device. A dialog sample including a diversity feature of a sentence at a specific position in a dialog flow may be obtained, and then a large model is trained based on the sample, to reduce an amount of data inputted into the model and improve training efficiency of the large model. In a trained large model, a sentence at a position that needs to be generated needs to be recalled as reference phrasing, to accurately generate a corresponding response sentence, thereby reducing an amount of data inputted into the model, and improving generation efficiency of the large model.

According to an aspect, a data processing method is provided. In the method, a first dialog sample is obtained. The first dialog sample includes a first set of words. A first position of the first set of words in a dialog flow is determined to obtain a flow label of the first set of words. A second set of words in a library is determined based on the flow label of the first set of words. When a flow label of the second set of words matches the flow label of the first set of words, the second set of words with the first dialog sample is fused to obtain a second dialog sample.

In an aspect, the second sentence having the same flow label is determined in the preset sentence library based on the first flow label of the first sentence, and the second sentence is fused with the first dialog sample, to obtain the second dialog sample. Therefore, a feature quantity of a sentence at the first position at which the first sentence is located in a fused training sample is increased. In addition, feature diversity of the sentence at the first position in the second dialog sample is improved by adding the second sentence. Therefore, during training of the large model, only the foregoing dialog sample optimized for a specific position may need to be inputted to complete high-quality training of the large model, so as to greatly reduce an amount of data inputted to the model, and improve training efficiency of the large model. In addition, during actual application of the large model trained based on the sample, only a sentence at a position at which a sentence needs to be generated may need to be recalled as reference phrasing, to more accurately generate a corresponding response sentence, so as to reduce an amount of data inputted into the model, facilitating response sentence implementation of the large model having an input length limitation, and improving encoding and generation efficiency of the large model. In addition, the large model trained based on the sample generates the response sentence by using good-quality phrasing recalled based on a flow label as a reference. Therefore, when there is a change in phrasing at a specific stage in an application environment, phrasing of a response sentence generated by a prediction model may be modified by replacing with a high-quality sentence corresponding to a flow label at the position in a high-quality phrasing library, without a need to retrain the model. This can enhance flexibility of the model.

According to an aspect, a response sentence generating method is provided. The method includes obtaining dialog data and basic information of a dialog subject. The method includes predicting a position of a response sentence of the dialog data in a dialog flow, to obtain a third flow label. The method includes determining a ninth sentence in a preset sentence library based on the third flow label, a flow label of the ninth sentence being the same as the third flow label. Further, the method includes inputting the dialog data, the ninth sentence, and the basic information to a generation model to obtain the response sentence, the generation model being trained based on the second dialog sample in the first aspect.

According to an aspect, a data processing apparatus including processing circuitry is provided. The processing circuitry is configured to obtain a first dialog sample including a first set of words. The processing circuitry is configured to determine a first position of the first set of words in a dialog flow, to obtain a flow label of the first set of words. The processing circuitry is configured to determine a second set of words in a library based on the flow label of the first set of words. When a flow label of the second set of words matches the flow label of the first set of words, the processing circuitry is configured to fuse the second set of words with the first dialog sample, to obtain a second dialog sample.

According to an aspect, a response sentence generating apparatus is provided in this disclosure. The apparatus includes an obtaining module, a prediction module, a processing module, and a generation module. The obtaining module is configured to obtain dialog data and basic information of a dialog subject. The prediction module is configured to predict a position of a response sentence of the dialog data in a dialog flow, to obtain a third flow label. The processing module is configured to determine a ninth sentence in a preset sentence library based on the third flow label, a flow label of the ninth sentence being the same as the third flow label. The generation module is configured to input the dialog data, the ninth sentence, and the basic information to a generation model to obtain the response sentence, the generation model being trained based on the second dialog sample in the first aspect.

According to an aspect, an electronic device is provided in this disclosure. The electronic device includes a processor, a memory, and a computer program or instructions stored in the memory. The processor executes the computer program or the instructions to implement any of the methods of this disclosure.

According to an aspect, a non-transitory computer-readable storage medium is provided in this disclosure. The non-transitory computer-readable storage medium has a computer program or instructions stored thereon, which when executed by a processor, cause the processor to perform any of the methods of this disclosure.

According to an aspect, a computer program product is provided in this disclosure. The computer program product includes a computer program or instructions, and when the computer program or instructions are executed, are configured to perform any of the methods of this disclosure. For example, the computer program or the instructions are executed by a processor.

### BRIEF DESCRIPTION OF THE DRAWINGS

The following briefly introduces the accompanying drawings for describing aspects of this disclosure. The drawings in the following descriptions are some examples of this disclosure. Other examples are within the scope of this disclosure.

FIG. 1 is a schematic diagram of a data processing system according to an aspect of this disclosure.

FIG. 2 is a schematic flowchart of a data processing method according to an aspect of this disclosure.

FIG. 3 is a schematic diagram of performing masking on a first sentence according to an aspect of this disclosure.

FIG. 4 is a schematic flowchart of a response sentence generating method according to an aspect of this disclosure.

FIG. 5 is a schematic diagram of a response sentence generating method according to an aspect of this disclosure.

FIG. 6 is a composition block diagram of functional modules of a data processing apparatus according to an aspect of this disclosure.

FIG. 7 is a schematic diagram of a structure of an electronic device according to an aspect of this disclosure.

### DETAILED DESCRIPTION

Examples of terms involved in the aspects of the disclosure are briefly introduced. The descriptions of the terms are provided as examples only and are not intended to limit the scope of the disclosure.

The terms “first”, “second”, and the like in implementations of this disclosure are intended to distinguish between different objects rather than to indicate a particular sequence. In addition, the terms “include”, “have”, and any variant thereof are intended to cover a non-exclusive inclusion. For example, a process, a method, software, a product, or a device that includes a series of operations or units is not limited to the listed operations or units, but may further include an unlisted operation or unit, or may further include another inherent operation or unit of the process, the method, the product, or the device.

In implementations of this application, the term “and/or” describes an association relationship between associated objects and indicates that three relationships may exist.

In implementations of this application, the character “/” may represent that the associated objects before and after the character are in an “or” relationship.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In implementations of this disclosure, “higher than” may be expressed as the same concept as “greater than”, “lower than” may be expressed as the same concept as “less than”, “not lower than” may be expressed as the same concept as “higher than or equal to” or “greater than or equal to”, and “not higher than” may be expressed as the same concept as “lower than or equal to” or “less than or equal to”. In this disclosure, for the same solution, “equal to” may be used in combination with “less than”, or may be used in combination with “greater than”, but not in combination with “less than” and “greater than” at the same time. A case in which “equal to” is used in combination with “less than” is applicable to a technical solution used for “less than”. A case in which “equal to” is used in combination with “greater than” is applicable to a technical solution used for “greater than”.

In implementations of this disclosure, “of”, “corresponding/relevant”, “corresponding”, “indicated”, “associated”, and the like may be mixed with each other.

In implementations of this disclosure, “associated”, “corresponding/relevant”, “corresponding”, “is”, “of”, “being”, “belong to”, “as”, and “regarded as” may be mixed with each other sometimes.

In implementations of this disclosure, “connection” means various connection manners such as a direct connection or an indirect connection, to implement communication between devices. This is not limited thereto.

In implementations of this disclosure, “network” and “system” may be expressed by using the same concept, and a communication system is a communication network.

The following describes related content, concepts, meanings, technical problems, technical solutions, beneficial effects, and the like in implementations of this disclosure.

A large model dialog can simulate a human interaction process and dialog phrasing, to implement a more fluent dialog and interaction, but a large amount of dialog data is needed for the large model to learn. A general large model uses general data, and may be trained and learn from standardized data such as a book, an article, and news. However, the general data cannot satisfy a dialog requirement in a specific scenario, for example, a dialog scenario between a company's online customer service and a customer. In view of this, currently, real historical call data in the scenario is usually used for the large model to learn, so that the large model learns an interaction process and dialog phrasing in the scenario.

However, during training of the large model or generation of a response sentence, reference usually needs to be made to retrieved and recalled data as a basis for the training or the generation. Therefore, during the training of the large model or the generation of the response sentence through the large model, to obtain a high-quality result, usually, all dialog data in the scenario is retrieved and recalled as the basis for the training or the generation. However, the dialog data usually includes sentences in an entire dialog flow, resulting in a large amount of data inputted into the model during each time of training or generation, and low training efficiency and generation efficiency of the model.

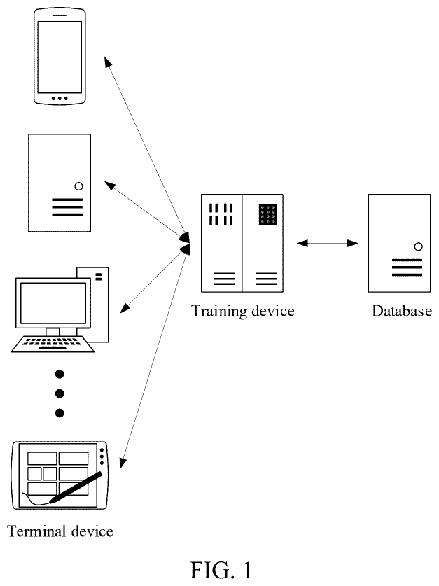

First, FIG. 1 is a schematic diagram of a data processing system according to an implementation of this disclosure. As shown in FIG. 1, the data processing system may include a terminal device and a database.

In an example, the terminal device obtains a first dialog sample from the database, or obtains a first dialog sample from a data processing request. For example, the data processing request may directly carry the first dialog sample, or carry an address of the first dialog sample. After obtaining the first dialog sample, the terminal device determines a first position of a first sentence in a dialog flow, to obtain a first flow label of the first sentence. Then, the terminal device determines, based on the first flow label in a sentence library preset in the database, a second sentence having a flow label identical to the first flow label. Finally, the terminal device fuses the second sentence with the first dialog sample, to obtain a second dialog sample.

Forms and quantities of the terminal devices and the databases shown in FIG. 1 are merely used as examples, and do not constitute a limitation on this disclosure.

In an example, the terminal device may be a device having a communication function and may be referred to as a terminal, user equipment (UE), a mobile station (MS), a mobile terminal (MT), an access terminal device, an on-board terminal device, an industrial control terminal device, a UE unit, a UE station, a remote station, a remote terminal device, a mobile device, a UE terminal device, a wireless communication device, a UE proxy, a UE apparatus, or the like. The terminal device may be fixed or mobile. The terminal device supports at least one wireless communication technology, such as LTE, new radio (NR), or wideband code division multiple access (WCDMA). For example, a training device and the terminal device may be mobile phones, pads, desktop computers, notebook computers, all-in-one machines, on-board terminals, virtual reality (VR) terminal devices, augmented reality (AR) terminal devices, wireless terminals in industrial control, wireless terminals in self-driving, wireless terminals in remote medical surgery, wireless terminals in a smart grid, wireless terminals in transportation safety, wireless terminals in a smart city, wireless terminals in smart home, cellular phones, cordless phones, session initiation protocol (SIP) phones, wireless local loop (WLL) stations, personal digital assistants (PDAs), handheld devices having a wireless communication function, computing devices or other processing devices connected to a wireless modem, wearable devices, terminal devices in a future mobile communication network, terminal devices in a future evolved public land mobile network (PLMN), or the like. In some implementations of this disclosure, the terminal device may alternatively be an apparatus having a transceiver function, for example, a chip system. The chip system may include a chip, and may further include another discrete component.

In an example, the terminal device may alternatively be a server, for example, an independent server, or a cloud server providing a basic cloud computing service, such as a cloud service, a cloud database, cloud computing, a cloud function, cloud storage, a network service, cloud communication, a middleware service, a domain name service, a security service, a content delivery network (CDN), or a big data and artificial intelligence platform. This is not limited in this disclosure.

In an example, the database may alternatively be a server, or a memory providing a data storage service, for example, a read-only memory (ROM), another type of static storage device that can store static information and instructions, a random-access memory (RAM), or another type of dynamic storage device that can store information and instructions, or an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, or the like), a magnetic storage medium or another magnetic storage device, or any other medium that can be configured to carry or store expected program code in a form of an instruction or a data structure and that can be accessed by a computer. This is not specifically limited in this disclosure.

In an example, the database may alternatively be a storage unit integrated in the training device and/or the terminal device, and is a component of the terminal device.

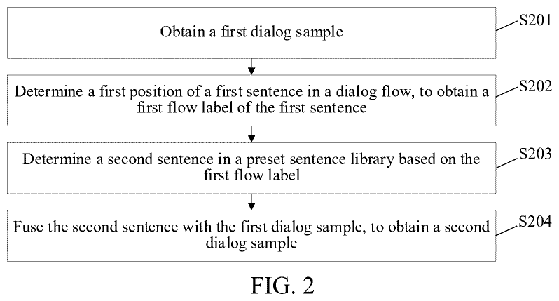

FIG. 2 is a schematic flowchart of a data processing method according to an implementation of this disclosure. The method is applied to the data processing system shown in FIG. 1, and may be specifically implemented by the terminal device in the data processing system. As shown in FIG. 2, the method includes the following operations.

S201: Obtain a first dialog sample.

In an example, the first dialog sample may include a first set of words (e.g., a sentence). The first sentence is a sentence configured for verifying training quality in the first dialog sample. In other words, the first sentence is configured for verifying, during training, whether a result outputted by a model reaches expected quality.

In an example, the first dialog sample may be determined based on call data in a real scenario. A telemarketing scenario is used as an example. Considering factors such as time validity, call data between a customer service and a customer in a telemarketing event in the telemarketing scenario within half a year may be obtained, to determine the first dialog sample. The call data may be audio data, or may be text data obtained through translation.

In an example, the call data is generated in real time during communication between the customer service and the customer, and a large amount of noise exists, for example, catchphrases, stuttering, unclear articulation, and errors when ASR converts speech to text. When the call data is directly used as the first dialog sample, the foregoing noise leads a large model to learn a noise-related feature, resulting in generation of low-quality response phrasing. In addition, abilities of different customer services or outbound marketing personnel are uneven, and low-quality phrasing data affects a problem-solving rate and a marketing effect. Therefore, the call data needs to be cleaned before training, to remove duplicated and low-quality data in the call data, so as to obtain available dialog data as the first dialog sample. For examples of the foregoing operations such as deduplication and quality screening, reference can be made to an existing text deduplication and quality screening process. Details are not described herein.

In an example, an example in which the first dialog sample is text data is used. The first dialog sample may include dialog text and basic information of a dialog subject, and the first sentence is a sentence in the dialog text. The dialog text may be considered as dialog text between a dialog person and the dialog subject. The dialog person may refer to a party having a dialog using a response sentence generated by a trained model. For example, in an intelligent telemarketing scenario, the dialog person may be a customer service or a seller who communicates with a customer by using a response sentence generated by a prediction model. In this scenario, the dialog subject is a customer having a dialog with the customer service or the seller.

In an example, the first sentence is a sentence for verifying a training effect. The trained model is configured to output the response sentence based on previous text, and a party using the model is the dialog person. The last sentence of text sent by the dialog person in the dialog text may be used as the first sentence, and all text before the first sentence in the dialog text is used as previous sentences of the first sentence. Therefore, in a training process, the model generates the response sentence by using the previous sentence of the first sentence and the basic information of the dialog subject as generation bases. Then, the generated response sentence is compared with the first sentence, to determine quality of the response sentence outputted by the model, so as to verify the training quality.

For example, the dialog data of the existing telemarketing scenario is as follows.

Customer service: Hi, is this Ms. Zhang?

Customer: Well, yes.

Customer service: Hello Ms. Zhang, it's a pleasure to contact you. I am the customer service specialist of XX company. I saw that you have received our health management gift package before, right?

Customer: Yes.

Customer service: I called you today to see how you feel about the gift package and whether there is anything that needs improvement.

Customer: Oh, OK, I think it's quite useful.

Customer service: Thanks for your feedback, Ms. Zhang. In fact, we also noticed that there was a free health consultation service in your gift package, worth 600 yuan, which you have not used yet. This service has a time limit and may not be available after it expires. We recommend that you make an appointment for the experience as soon as possible to protect your service rights.

In this example, the first sentence is the last sentence of text of the customer service: Thanks for your feedback, Ms. Zhang. In fact, we also noticed that there was a free health consultation service in your gift package, worth 600 yuan, which you have not used yet. This service has a time limit and may not be available after it expires. We recommend that you make an appointment for the experience as soon as possible to protect your service rights.

The previous sentence of the first sentence is all dialog text between the customer service and the customer before the first sentence:

Customer service: Hi, is this Ms. Zhang?

Customer: Well, yes.

Customer service: Hello Ms. Zhang, it's a pleasure to contact you. I am the customer service specialist of XX company. I saw that you have received our health management gift package before, right?

Customer: Yes.

Customer service: I called you today to see how you feel about the gift package and whether there is anything that needs improvement.

Customer: Oh, OK, I think it's quite useful.

In an example, the basic information of the dialog subject may be identity information of the dialog subject and/or service information in a corresponding scenario. For example, when the dialog subject is the customer in the foregoing telemarketing scenario, the basic information may include a name, a mobile number, current time, a customer label, service-related information, and the like. The foregoing example continues to be used. The basic information of the dialog subject may be as follows:

#Current time: 7:14 pm #Name: Ms. Zhang #Mobile phone number ending in 5105 #Registration time: Jun. 13, 2020 #Registration channel diversion #Health management gift package #Received for 7 days #Unused health consultation service #Service value: 600 #Connected once #Customer label: None

S202: Determine a first position of the first sentence in a dialog flow, to obtain a first flow label of the first sentence.

In an example, the dialog flow may be divided based on an actual scenario and requirement corresponding to the dialog, to obtain a plurality of positions, or plurality of stages. For example, as shown in Table 1, a dialog flow in the telemarketing scenario may be divided into 8 positions: opening remarks, awakening memory, service introduction, objection handling, operation guidance, facilitation, closing remarks, and others.

TABLE 1

| Texts | Process stage |
|---|---|
| Hi, is this Ms. Zhang? | Opening remarks |
| Hello Ms. Zhang, I am the customer service specialist of XX company. You | Awakening |
| have received our health management gift package before, right? | memory |
| We noticed that the gift package includes a free health consultation service, | Service |
| which is designed to help you understand your personal health status and | introduction |
| provide professional advice. You haven't used it before. | |
| We understand that you are busy. This consultation service can be | Objection handling |
| completed online. It only takes 15 minutes and will not take up too much of | |
| your time. You will not be able to enjoy the free benefits after the | |
| expiration date. That would be a pity. | |
| OK, we have made an appointment for you for the health consultation | Facilitation |
| service at 3 pm on Friday. When the time comes, you just need to click on | |
| the link we sent to enter the consultation page. It's very simple. | |
| How about this, Ms. Zhang, I can help you make an appointment quickly | Operation guidance |
| on our system. Could you please tell me which day you have 15 minutes of | |
| free time? | |
| We would also like to remind you that after completing the consultation, | Others |
| don't forget to fill in the feedback. We have a small gift for you as well! | |
| Thanks for your cooperation, Ms. Zhang! I wish you a pleasant use. If you | Closing remarks |
| have other needs, please feel free to contact us. Have a good day! | |

For this scenario, respective position names of the foregoing eight positions may be used as respective corresponding flow labels. In addition, the eight positions do not necessarily appear in an order of the above table during the dialog. Generally, except for the stage [Opening remarks] appearing at the first position of the dialog and the stage [Closing remarks] appearing at the last position of the dialog, an order of other positions in the dialog flow may be arbitrary.

In an example, a preceding sentence of the first sentence in the previous sentence may be used as a third sentence, a second flow label of the third sentence is obtained, and the first flow label of the first sentence is determined with reference to an intention of the first sentence.

The foregoing example continues to be used. The third sentence is:

I called you today to see how you feel about the gift package and whether there is anything that needs improvement.

In an example, the second flow label corresponding to the third sentence is [Service introduction].

Then, intention extraction may be performed on the first sentence, to obtain intention information. Then, a plurality of positions in the dialog flow are determined based on the second flow label of the third sentence and the intention information. Specifically, for each dialog scenario, there is usually a fixed dialog flow, and the flow may be obtained based on statistical analysis on historical call data in the scenario. Therefore, based on the second flow label of the third sentence and with reference to the dialog flow obtained based on the historical call data, in the scenario, a position after a position corresponding to the second flow label may be determined, and then the position corresponding to the second flow label and the position after the position corresponding to the second flow label are used as the plurality of positions that need to be determined.

For example, after statistical analysis on the historical call data, the obtained dialog flow is:
[Opening remarks]-[Service introduction]-[Facilitation]-[Objection handling]-[Operation guidance]-[Closing remarks].

Therefore, when the second flow label is [Service introduction], a corresponding position is [Service introduction] in the dialog flow, and positions located after [Service introduction] include [Facilitation], [Objection handling], [Operation guidance], and [Closing remarks]. Therefore, based on the second flow label [Service introduction], five positions may be determined, and are respectively [Service introduction], [Facilitation], [Objection handling], [Operation guidance], and [Closing remarks].

In an example, after the plurality of positions are determined, intention extraction may be performed on the first sentence, to obtain the intention information, and then similarities between the intention information and screened intentions corresponding to all second process stages are calculated, to obtain a plurality of first similarities. A second process stage that is in the plurality of second process stages and that has a similarity greater than or equal to a first threshold is obtained, to obtain a plurality of candidate stages.

Then, keyword extraction is performed on the first sentence, to obtain a plurality of first keywords. A target stage is determined, in the plurality of candidate stages, as a stage of the first sentence in the dialog flow based on the plurality of first keywords. Specifically, the plurality of first keywords may be compared with a keyword group in each candidate stage, to determine a keyword overlap ratio. Then, a candidate stage having a highest overlap ratio is used as the stage of the first sentence in the dialog flow, and a flow label corresponding to the stage is obtained as the first flow label of the first sentence.

When there is no preceding sentence of the first sentence, in other words, there is no third sentence, the first flow label of the first sentence may be directly determined as a position name of the first position in the dialog flow, for example, opening remarks.

In an example, if each sentence of dialog text in the first dialog sample is not marked with a flow label, the foregoing method may be used to sequentially determine, starting from the first sentence of the dialog text, a flow label of each sentence in the dialog text.

In an example, the foregoing flow label marking may alternatively be implemented by training a marking model. Specifically, dialog text having a marked flow label may be inputted as training data into a classification model for training, to obtain the marking model. Then, when the flow label of the first sentence needs to be determined, dialog text including the first sentence may be inputted into the trained marking model, to obtain the flow label of the first sentence. A Bert classification model may be used as an initial classification model. For an example of a training method, reference can be made to an existing method of training a classification model with a label. Details are not described herein.

In an example, after the flow label of each sentence in the dialog text is determined, the flow label of each sentence may be marked in front of a corresponding sentence, to obtain dialog text carrying the flow label. The example in the foregoing telemarketing scenario continues to be used. The following dialog text carrying flow labels may be obtained.

Customer service: [Opening remarks] Hi, is this Ms. Zhang?

Customer: Well, yes.

Customer service: [Awakening memory] Hello Ms. Zhang, it's a pleasure to contact you. I am the customer service specialist of XX company. I saw that you have received our health management gift package before, right?

Customer: Yes.

Customer service: [Service introduction] I called you today to see how you feel about the gift package and whether there is anything that needs improvement.

Customer: Oh, OK, I think it's quite useful.

Customer service: [Service introduction] Thanks for your feedback, Ms. Zhang. In fact, we also noticed that there was a free health consultation service in your gift package, worth 600 yuan, which you have not used yet. This service has a time limit and may not be available after it expires. We recommend that you make an appointment for the experience as soon as possible to protect your service rights.

S203: Determine a second sentence in a preset sentence library based on the first flow label.

In an example, a flow label of the second sentence is matched the first flow label of the first sentence, which means a sentence that is located at a position corresponding to the first flow label in the dialog flow is obtained from the preset sentence library as the second sentence.

In an example, the sentence library may be a preset good-quality phrasing library. The good-quality phrasing library is configured to store a good-quality sentence that passes screening and carries a flow label. Specifically, the cleaned and marked dialog data in operation S201 may be split, and each single sentence obtained through splitting is stored, based on a marked flow label of the single sentence, under a corresponding flow label in the good-quality phrasing library, as a good-quality sentence under the flow label. In addition, quality screening may also be performed on a sentence of which a flow label is determined in each first dialog sample in operation S202, and a sentence that passes the quality screening is stored, based on a flow label of the sentence, under a corresponding flow label in the good-quality phrasing library, as a good-quality sentence under the flow label, to automatically update and supplement the good-quality phrasing library.

Based on this, after the first flow label of the first sentence in the first dialog sample is determined, some or all of good-quality sentences under the first flow label in the good-quality phrasing library may be obtained as the second sentence corresponding to the first dialog sample.

S204: Fuse the second sentence with the first dialog sample, to obtain a second dialog sample.

In an example, first, the first sentence and the second sentence may be concatenated, to obtain a fourth sentence. Before the first sentence and the second sentence are concatenated, the first sentence and the second sentence further need to be preprocessed, to eliminate some unnecessary features in the first sentence and the second sentence, so that a proportion of features contributing to training of the large model in a finally obtained second sample is larger, to improve training quality when the second dialog sample is used to train the large model.

Specifically, the unnecessary feature may mean personal information in a sentence, for example, information such as identity information and service information related to the dialog person and/or the dialog subject. These pieces of information are different due to different personal identities or services, and is not affected by a dialog scenario. Therefore, this information does not contribute much to generation of the response sentence and may be classified as the unnecessary feature.

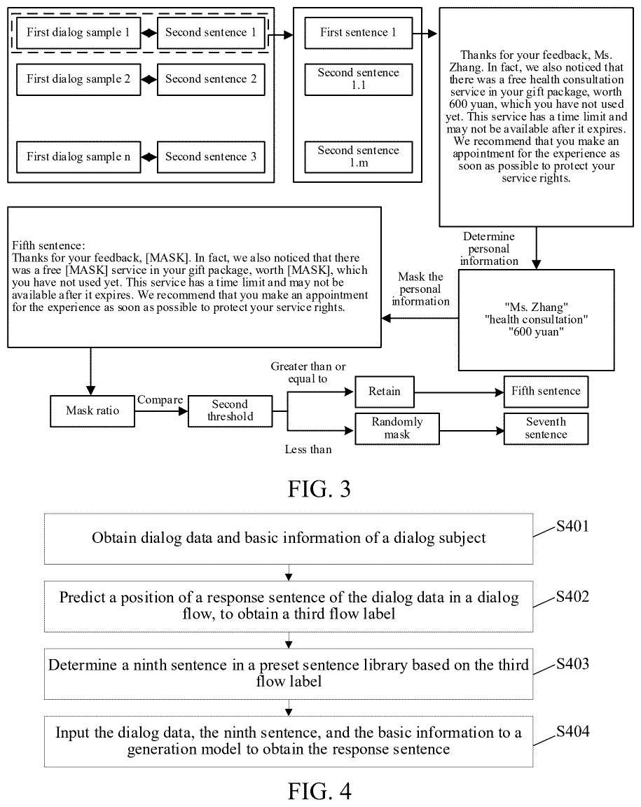

In an example, as shown in FIG. 3, personal information in the first sentence may first be masked, to obtain a fifth sentence, and personal information in the second sentence may be masked, to obtain a sixth sentence. For example, if the first sentence is as follows:

Thanks for your feedback, Ms. Zhang. In fact, we also noticed that there was a free health consultation service in your gift package, worth 600 yuan, which you have not used yet. This service has a time limit and may not be available after it expires. We recommend that you make an appointment for the experience as soon as possible to protect your service rights.

“Ms. Zhang”, “health consultation”, and “600 yuan” are identity information or service information related to the customer, and have no guiding effect on generation of subsequent sentences. In addition, retaining these pieces of information may further cause the trained model to be correspondingly affected. These pieces of information are used as references for sentence generation, so that a generated sentence includes corresponding information, resulting in an outputted sentence being inconsistent with an actual situation, causing customer questions and complaints. Therefore, the personal information may be masked, to obtain the following fifth sentence:

Thanks for your feedback, [MASK]. In fact, we also noticed that there was a free [MASK] service in your gift package, worth [MASK], which you have not used yet. This service has a time limit and may not be available after it expires. We recommend that you make an appointment for the experience as soon as possible to protect your service rights.

Then, a first mask ratio of the fifth sentence and a second mask ratio of the sixth sentence can be determined. The first mask ratio may be understood as a ratio of a character length of a mask part in the fifth sentence to an overall character length of the fifth sentence. The second mask ratio may be understood as a ratio of a character length of a mask part in the sixth sentence to an overall character length of the sixth sentence. The foregoing fifth sentence is used as an example. The three [MASK] s correspond to “Ms. Zhang”, “health consultation”, and “600 yuan”, respectively, and a character length of the three [MASK] s is 10. If the character length of the fifth sentence is 95, the first mask ratio of the fifth sentence is 10.5%.

In an example, after preprocessing is completed, the fourth sentence may be obtained based on the first mask ratio, the second mask ratio, the fifth sentence, and the sixth sentence. For example, a second threshold may be preset, and the first mask ratio and the second mask ratio are separately compared with the second threshold. Specifically, if the first mask ratio or the second mask ratio is greater than or equal to the second threshold, a corresponding sentence is qualified, and does not need to be processed. If the first mask ratio or the second mask ratio is less than the second threshold, a corresponding statement is unqualified, and needs to be further masked.

Specifically, in a case that the first mask ratio and the second mask ratio are both greater than or equal to the second threshold, the fifth sentence and the sixth sentence may be directly concatenated, to obtain the fourth sentence. In a case that the first mask ratio and/or the second mask ratio is less than the second threshold, masking is performed on the fifth sentence to obtain a seventh sentence having a mask ratio greater than or equal to the second threshold, and masking is performed on the sixth sentence to obtain an eighth sentence having a mask ratio greater than or equal to the second threshold; and the seventh sentence and the eighth sentence are concatenated to obtain the fourth sentence.

In short, in the fifth sentence and the sixth sentence, masking is further performed on a sentence having a mask ratio less than the second threshold, to obtain a sentence having a mask ratio greater than or equal to the second threshold. Then, sentences having qualified mask ratios (greater than or equal to the second threshold) are concatenated, to obtain the fourth sentence.

In an example, an objective of controlling a mask ratio of a sentence to be greater than or equal to the second threshold is to reduce features in the sentence, so that a limitation in the sentence is further reduced, and then the large model is trained with few features. In this way, a trained large model has a stronger prediction effect and generalization capability. This plays a supportive role in generation by the large model and selecting high-quality phrasing.

Specifically, a value of the second threshold may be 50%. The fifth sentence is used as an example. After calculation, the mask ratio of the fifth sentence is 10.5%, which is less than the second threshold 50%. Then, it is necessary to randomly mask phrases in the fifth sentence to obtain the seventh sentence having a mask ratio of 50%. For example,

Thanks for [MASK] feedback, [MASK]. In fact, [MASK] also noticed that there was a [MASK] [MASK] service in your [MASK], worth [MASK], which you have [MASK] [MASK]. This [MASK] has [MASK] and may [MASK] [MASK]. [MASK] [MASK] you make an appointment [MASK] [MASK], [MASK] service [MASK].

In an example, the sentences having mask ratios greater than or equal to the second threshold obtained in the foregoing examples may be concatenated in a random concatenation manner. For example, the sentences having mask ratios greater than or equal to the second threshold may be shuffled and then concatenated. During training, these sentences are used as reference sentences for the large model to generate response sentences. Therefore, if the sentences are not shuffled, a position of a sentence that has a mask ratio greater than or equal to the second threshold and that corresponds to the first sentence is fixed in concatenation. Because the first sentence is also a sentence for verifying a prediction effect of the model, during training of the large model, the large model may learn to generate a response sentence with reference to only a sentence at a position in concatenation of a sentence that has a mask ratio greater than or equal to the second threshold and that corresponds to the first sentence, and ignore a sentence in a sample that has a mask ratio greater than or equal to the second threshold and that corresponds to the second sentence. The sentences having mask ratios greater than or equal to the second threshold are shuffled and then concatenated, so that the position in concatenation of the sentence that has the mask ratio greater than or equal to the second threshold and that corresponds to the first sentence is random, and the large model no longer learns to only refer to a sentence at a particular position, but learns to find, from a plurality of sentences, a sentence that best satisfies a current scenario as a reference to generate a response sentence, thereby greatly improving quality of a response sentence generated by the trained large model.

In an example, after the fourth sentence is obtained, the fourth sentence, the basic information of the dialog subject in the first dialog sample, and the previous sentence may be concatenated, to obtain the second dialog sample. Specifically, the fourth sentence, the previous sentence, and the basic information may be concatenated in an order of “the fourth sentence—the basic information—the previous sentence”, to obtain the second dialog sample.

In conclusion, in this method, the second sentence having the same flow label is determined in the preset sentence library based on the first flow label of the first sentence, and the second sentence is fused with the first dialog sample, to obtain the second dialog sample. Therefore, a feature quantity of a sentence at the first position at which the first sentence is located in a fused training sample is increased. In addition, feature diversity of the sentence at the first position in the second dialog sample is improved by adding the second sentence. Therefore, during training of the large model, only the foregoing dialog sample optimized for a specific position needs to be inputted to complete high-quality training of the large model, so as to greatly reduce an amount of data inputted to the model, and improve training efficiency of the large model. In the large model trained based on the sample, a sentence at a position at which a sentence needs to be generated needs to be recalled as reference phrasing, to accurately generate a corresponding response sentence, so as to greatly reduce an amount of data inputted into the model, facilitating response sentence generation of the large model having an input length limitation, and improving encoding and generation efficiency of the large model. In addition, the large model trained based on the sample generates the response sentence by using good-quality phrasing recalled based on a flow label as a reference. Therefore, when there is a change in phrasing at a specific environment, phrasing of a response sentence generated by a prediction model may be modified by replacement with a high-quality sentence corresponding to a flow label at the position in a high-quality phrasing library, without a need to retrain the model. This greatly enhances flexibility of the model.

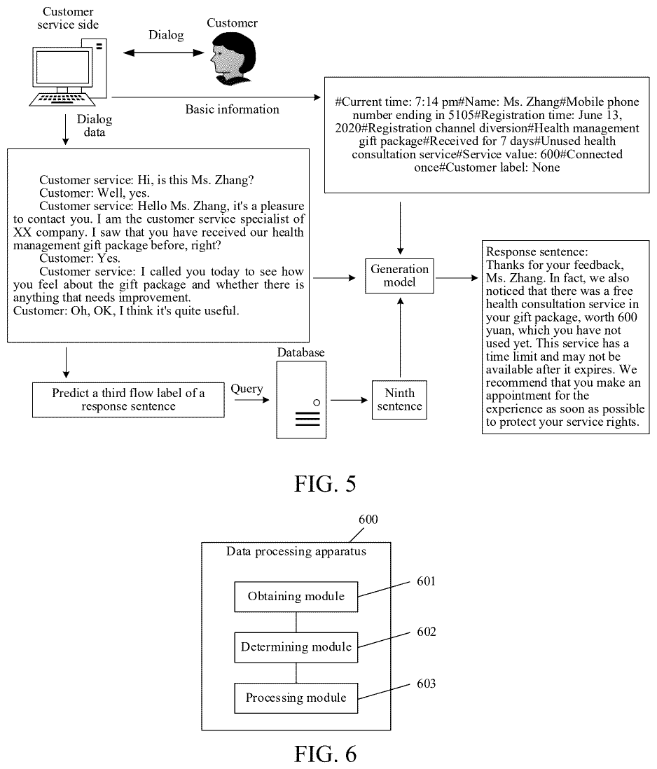

Corresponding to the data processing method described in FIG. 2 and FIG. 3, based on a same technical concept, an example of this disclosure further provides a response sentence generating method. FIG. 4 is a schematic flowchart of a response sentence generating method according to an example of this disclosure, and FIG. 5 is a schematic diagram of a response sentence generating method according to an example of this disclosure. The method includes the following operations.

S401: Obtain dialog data and basic information of a dialog subject.

In an example, the dialog data may be considered as real-time dialog text between a dialog person and a dialog subject. The text ends with the latest speech of the dialog subject. The method is to analyze the dialog data and output a response sentence configured for replying to the latest speech of the dialog subject. The dialog person refers to a party having a dialog using a response sentence predicted and generated by a trained prediction model. For example, in an intelligent telemarketing scenario, the dialog person may be a customer service or a seller who communicates with a customer by using a response sentence generated by the prediction model, and the dialog subject may be the customer. The basic information of the dialog subject may be identity information of the dialog subject and/or service information in a corresponding scenario. For example, when the dialog subject is the customer in the foregoing telemarketing scenario, the basic information may include a name, a mobile number, current time, a customer label, service-related information, and the like. The basic information may be found in a system by using the identity information of the dialog subject. In addition, an intention of the dialog subject in this dialog may be recognized in real time based on the dialog data, to add the intention to the basic information. The foregoing intention recognition method may include a related intention recognition method in some aspects.

A telemarketing scenario is used as an example. The real-time dialog data may be as follows:

Customer service: Hi, is this Ms. Zhang?

Customer: Well, yes.

Customer service: Hello Ms. Zhang, it's a pleasure to contact you. I am the customer service specialist of XX company. I saw that you have received our health management gift package before, right?

Customer: Yes.

Customer service: I called you today to see how you feel about the gift package and whether there is anything that needs improvement.

Customer: Oh, OK, I think it's quite useful. The last sentence is “Oh, OK, I think it's quite useful” uttered by the customer. In this disclosure, the dialog data is analyzed, to generate a response sentence for replying to the speech.

In this scenario, the basic information of the dialog subject may be obtained by querying a system based on information such as a phone number, a name, and an identity of the dialog subject. The following provides an example of the basic information:

#Current time: 7:14 pm #Name: Ms. Zhang #Mobile phone number ending in 5105 #Registration time: Jun. 13, 2020 #Registration channel diversion #Health management gift package #Received for 7 days #Unused health consultation service #Service value: 600 #Connected once #Customer label: None

The foregoing example is merely an example for describing this solution in detail, and is not intended to limit content and a format of the basic information of this solution.

S402: Predict a position of a response sentence of the dialog data in a dialog flow, to obtain a third flow label.

In an example, the response sentence is a sentence generated by predicting by using the method, or the response sentence is a next sentence that needs to be predicted, and the third flow label is configured for identifying a position of the response sentence in the dialog flow.

In an example, the third flow label of the response sentence may be determined by using the method of determining the first flow label of the first sentence in operation S202, and details are not described again.

S403: Determine a ninth sentence in a preset sentence library based on the third flow label.

In an example, the sentence library may be a preset high-quality phrasing library in a database, and all or some of high-quality sentences under corresponding labels in the high-quality phrasing library may be obtained based on the third flow label, to obtain the ninth sentence. In short, a flow label of the ninth sentence is the same as the third flow label of the response sentence.

S404: Input the dialog data, the ninth sentence, and the basic information to a generation model to obtain the response sentence.

In an example, the generation model is trained based on the second dialog sample in the data processing method described in FIG. 2 and FIG. 3. Specifically, a plurality of second dialog samples processed by using the data processing method described in FIG. 2 and FIG. 3 may be inputted to an original model, to obtain a plurality of tenth sentences in one-to-one correspondence with the plurality of second dialog samples. Then, a training loss is determined based on each tenth sentence and a first sentence in a second dialog sample corresponding to the tenth sentence, and iterative adjustment is performed on a parameter of the original model based on the training loss, to obtain the prediction model.

Specifically, for each tenth sentence, a cross-entropy loss between the tenth sentence and the corresponding first sentence may be calculated, and a plurality of obtained cross entropy losses are averaged, to obtain the training loss. Certainly, a loss between each tenth statement and a corresponding first sentence may alternatively be calculated by using another loss calculation manner, for example, a bilingual evaluation understudy (BLEU) loss, a recall-oriented understudy for Gisting Evaluation (ROUGE) loss, and a self-defined loss. This is not limited in this disclosure.

In an example, the original model may be a large dialog model, for example, a chat generative pre-trained transformer (ChatGPT), a text-to-text transfer transformer (T5) model, and an enhanced representation through knowledge integration (ERNIE) model. This is not limited in this disclosure.

Therefore, a flow label is introduced in model training, to identify a position of the to-be-predicted first sentence in the dialog flow. Then, a second sentence of a corresponding flow is obtained based on the flow label, and the second sentence is fused with a first dialog sample, to obtain a second dialog sample to train the original model, so that a trained large model may predict and generate, for a flow label of input data, a response sentence under the flow label. In this way, when the large model is used to generate a response sentence, a corresponding response sentence can be accurately generated only by recalling a sentence at a corresponding position as reference phrasing, to improve focus of the large model on a single task and a prediction effect. In addition, an amount of data inputted into the large model is reduced, to facilitate response sentence generation of the large model having an input length limitation, and improve encoding and model generation efficiency. In addition, the large model trained by using the foregoing method generates the response sentence by using good-quality phrasing recalled based on a flow label as a reference. Therefore, when there is a change in phrasing at a specific stage environment, phrasing of a response sentence generated by the large model may be modified by replacing with a high-quality sentence corresponding to a flow label at the position in a high-quality phrasing library, without a need to retrain the large model. This greatly enhances flexibility of the large model.

The above mainly describes the solutions of this disclosure from a perspective of a method side. To implement the foregoing functions, a training device includes a corresponding hardware structure and/or software module for performing the functions. A person skilled in the art is to be easily aware that, with reference to units and algorithm operations of the examples described in this specification, may be implemented by hardware or a combination of hardware and computer software. Whether a function is performed by hardware or hardware driven by computer software depends on particular applications and design constraints of the technical solutions. Other methods to implement the described functions are within the scope of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In an example of this disclosure, a terminal device may be divided into functional units based on the foregoing method examples. For example, each functional module may be obtained through division based on each corresponding function, or two or more functions may be integrated into one functional module. The integrated module may be implemented in the form of hardware, or may be implemented in the form of a software program module. In examples of this disclosure, module division is an example, and is merely a logical function division. Another division manner may be used.

In a case that the integrated module is used, FIG. 6 is a composition block diagram of functional modules of a data processing apparatus according to an example of this disclosure. A data processing apparatus 600 includes an obtaining module 601, a determining module 602, and a processing module 603.

In an example, the obtaining module 601, the determining module 602, and the processing module 603 may be modules configured to receive and process a signal, information, and the like or determine a monitoring mechanism, which is not specifically limited.

In an example, the data processing apparatus 600 may further include a storage module, configured to store computer program code or instructions executed by the data processing apparatus 600. The storage module may be a memory.

In an example, the data processing apparatus 600 may be a chip or a chip module.

In an example, the obtaining module 601, the determining module 602, and the processing module 603 may be integrated into a communication module. The communication module may be a communication interface, a transceiver, a transceiver circuit, or the like.

In an example, the obtaining module 601, the determining module 602, and the processing module 603 may be integrated in a processor.

The processor may be a baseband processor, a baseband chip, a central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The processor may implement or perform various example logical blocks, modules, and circuits described with reference to content disclosed in this disclosure. Alternatively, the processing module may be a combination for implementing computing functions, for example, a combination of one or more microprocessors, or a combination of a DSP and a microprocessor.

In an example, the data processing apparatus 600 is configured to perform any operation performed by the terminal device/chip/chip module or the like in the foregoing method.

The obtaining module 601, the determining module 602, and the processing module 603 are configured to perform any operation in the foregoing method, and when performing an action such as sending, may invoke another module to complete a corresponding operation. Detailed descriptions are provided below.

The obtaining module 601 is configured to obtain a first dialog sample, the first dialog sample including a first sentence;
the determining module 602 is configured to: determine a first position of the first sentence in a dialog flow, to obtain a first flow label, and determine a second sentence in a preset sentence library based on the first flow label, a flow label of the second sentence being the same as the first flow label; and
the processing module 603 is configured to fuse the second sentence with the first dialog sample, to obtain a second dialog sample.

In an example, in terms of determining the first position of the first sentence in the dialog flow, to obtain the first flow label, the determining module 602 is specifically configured to:
determine a preceding sentence of the first sentence in the first dialog sample, to obtain a third sentence;
perform intention extraction on the first sentence, to obtain intention information;
determine a plurality of positions in the dialog flow based on a second flow label of the third sentence and the intention information;
perform keyword extraction on the first sentence, to obtain a plurality of first keywords;
determine, in the plurality of positions, the first position of the first sentence in the dialog flow based on the plurality of first keywords; and
obtain a flow label corresponding to the first position, to obtain the first flow label.

In an example, in terms of determining the plurality of positions in the dialog flow based on the second flow label of the third sentence and the intention information, the determining module 602 is specifically configured to:
obtain, in the dialog flow, a second position corresponding to the second flow label and a position after the second position, to obtain a plurality of third positions;
determine a similarity between the intention information and an intention corresponding to each third position, to obtain a plurality of first similarities; and
obtain a third position that is in the plurality of third positions and that has a first similarity greater than or equal to a first threshold, to obtain the plurality of positions.

In an example, in terms of determining, in the plurality of positions, the first position of the first sentence in the dialog flow based on the plurality of first keywords, the determining module 602 is specifically configured to:
determine an overlap ratio between a keyword group in each of the plurality of positions and the plurality of first keywords; and
use a position having a highest overlap ratio as the first position.

In an example, in terms of fusing the second sentence with the first dialog sample, to obtain the second dialog sample, the processing module 603 is specifically configured to:
concatenate the first sentence and the second sentence, to obtain a fourth sentence; and
concatenate the fourth sentence, basic information of a dialog subject in the first dialog sample, and a previous sentence, to obtain the second dialog sample.

In an example, in terms of concatenating the second sentence and the first sentence, to obtain the fourth sentence, the processing module 603 is specifically configured to:
mask personal information in the first sentence to obtain a fifth sentence;
mask personal information in the second sentence to obtain a sixth sentence;
determine a first mask ratio of the fifth sentence and a second mask ratio of the sixth sentence, a mask ratio being a ratio of a character length corresponding to a mask part in a sentence to a character length of the sentence; and
obtain the fourth sentence based on the first mask ratio, the second mask ratio, the fifth sentence, and the sixth sentence.

In an example, in terms of obtaining the fourth sentence based on the first mask ratio, the second mask ratio, the fifth sentence, and the sixth sentence, the processing module 603 is specifically configured to:
concatenate, in a case that the first mask ratio and the second mask ratio are both greater than or equal to a second threshold, the fifth sentence and the sixth sentence to obtain the fourth sentence; or
perform masking, in a case that the first mask ratio and/or the second mask ratio is less than a second threshold, on the fifth sentence to obtain a seventh sentence having a mask ratio greater than or equal to the second threshold, and perform masking on the sixth sentence to obtain an eighth sentence having a mask ratio greater than or equal to the second threshold; and
concatenate the seventh sentence and the eighth sentence to obtain the fourth sentence

Corresponding to the foregoing response sentence generating method described in FIG. 4, based on the same technical concept, an example of this disclosure further provides a response sentence generating apparatus. The apparatus includes:
an obtaining module, configured to obtain dialog data and basic information of a dialog subject;
a prediction module, configured to predict a position of a response sentence of the dialog data in a dialog flow, to obtain a third flow label;
a processing module, configured to determine a ninth sentence in a preset sentence library based on the third flow label, a flow label of the ninth sentence being the same as the third flow label; and
a generation module, configured to input the dialog data, the ninth sentence, and the basic information to a generation model to obtain the response sentence.

In an example, the generation model is trained based on the second dialog sample obtained by using the data processing method described in FIG. 2 and FIG. 3. For examples of processes and training effect of the training process, reference can be made to the data processing method described in FIG. 2 and FIG. 3 and the response sentence generating method described in FIG. 4 and FIG. 5. Details are not described herein again.

The response sentence generating apparatus in this disclosure is based on the same concept as the data processing method and the response sentence generating method in this disclosure. Therefore, details are not described herein again.

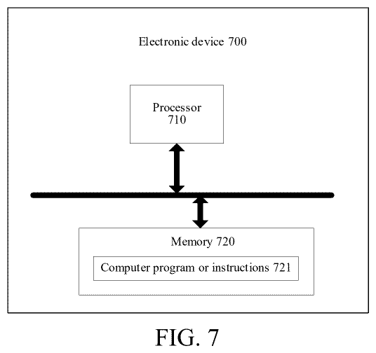

FIG. 7 is a schematic diagram of a structure of an electronic device according to an example of this disclosure. The electronic device 700 may include processing circuitry, such as a processor 710, a memory 720, such as a non-transitory computer-readable storage medium, and a communication bus configured to connect the processor 710 and the memory 720.

In one embodiment, the memory 720 includes, but is not limited to, a random access memory (RAM), a read-only memory (ROM), an erasable programmable read-only memory (EPROM), or a compact disc read-only memory (CD-ROM). The memory 720 is configured to store program code executed and data transmitted by the electronic device 700.

In an example, the electronic device 700 further includes a communication interface, configured to receive and send data.

In an example, the processor 710 may be one or more CPUs. In a case that the processor 710 is one CPU, the CPU may be a single-core CPU, or may be a multi-core CPU.

In an example, the processor 710 may be a baseband chip, a chip, a CPU, a general-purpose processor, a DSP, an ASIC, an FPGA or another programmable logic device, a transistor logic device, a hardware component, or any combination thereof.

The processor 710 in the electronic device 700 is configured to execute a computer program or instructions 721 stored in the memory 720, to perform the following operations:
obtaining a first dialog sample, the first dialog sample including a first sentence;
determining a first position of the first sentence in a dialog flow, to obtain a first flow label of the first sentence;
determining a second sentence in a preset sentence library based on the first flow label, a flow label of the second sentence being the same as the first flow label of the first sentence; and
fusing the second sentence with the first dialog sample, to obtain a second dialog sample.

Alternatively, the processor 710 in the electronic device 700 is configured to execute a computer program or instructions 721 stored in the memory 720, to perform the following operations:
obtaining dialog data and basic information of a dialog subject;
predicting a position of a response sentence of the dialog data in a dialog flow, to obtain a third flow label;
determining a ninth sentence in a preset sentence library based on the third flow label, a flow label of the ninth sentence being the same as the third flow label; and
inputting the dialog data, the ninth sentence, and the basic information to a generation model to obtain the response sentence, the generation model being trained based on the second dialog sample in the data processing method described in FIG. 2 and FIG. 3.

For examples of operations in FIG. 7, reference can be made to descriptions in the foregoing method, and details are not described herein again.

An example of this disclosure also provides a computer-readable storage medium having a computer program or instructions stored thereon. When the computer program or the instructions are executed, the operations described in the foregoing method are performed.

An example of this disclosure also provides a computer program product, including a computer program or instructions. When the computer program or the instructions are executed, the operations described in the foregoing method are performed.

For ease of description, the foregoing examples are described as a series of action combinations. This disclosure is not limited to an order of described actions, because some operations in this disclosure may be performed in other orders or simultaneously. In addition, a person skilled in the art also knows that some of the related actions, operations, modules, or units are not necessarily required in this disclosure.

The description of this disclosure has respective emphasis. For any parts that are not described in detail in an example, reference can be made to the relevant descriptions of other examples.

Operations of the method or algorithm described in examples of this disclosure may be implemented by hardware, or may be implemented by a processor executing software instructions. The software instructions may include a corresponding software module, and the software module may be stored in a RAM, a flash memory, a ROM, an EPROM, an electrically erasable programmable read-only memory (EEPROM), a register, a hard disk drive, a removable hard disk drive, a compact disc read-only memory (CD-ROM), or any other form of storage medium well-known in the art. For example, a storage medium is coupled to a processor, so that the processor can read information from the storage medium or write information into the storage medium. Certainly, the storage medium may be a component of the processor. The processor and the storage medium may be located in an ASIC. In addition, the ASIC may be located in a terminal device or a management device. Certainly, the processor and the storage medium may alternatively exist in the terminal device or the management device as discrete components.

A person skilled in the art is to be aware that in the one or more examples, all or some the functions described in examples of this disclosure may be implemented by using hardware, software, firmware, or any combination thereof. When the functions are implemented by using the software, all or some of the functions may be implemented in the form of a computer program product. The computer program product includes one or more computer instructions. When the computer program instructions are loaded and executed on a computer, all or some of the processes or functions described based on examples of this disclosure are generated. The computer may be a general-purpose computer, a dedicated computer, a computer network, or other programmable apparatuses. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a digital video disc (DVD)), a semiconductor medium (for example, a solid-state disk (SSD)), or the like.

The modules/units included in the apparatuses and products described in the foregoing examples may be software modules/units, or may be hardware modules/units, or may be partially software modules/units and partially hardware modules/units. For example, for each apparatus or product used in or integrated into a chip, modules/units included in the apparatus or product may be implemented by using hardware such as a circuit, or at least some modules/units may be implemented by using a software program. The software program runs on a processor integrated inside the chip, and some remaining (if any) modules/units may be implemented by using hardware such as a circuit. For each apparatus or product used in or integrated into a chip module, modules/units included in the apparatus or product may be implemented by using hardware such as a circuit. Different modules/units may be located in a same component (for example, a chip or a circuit module) or different components of the chip module. Alternatively, at least some modules/units may be implemented by using a software program. The software program runs on a processor integrated inside the chip module, and some remaining (if any) modules/units may be implemented by using hardware such as a circuit. For each apparatus or product used in or integrated into a terminal device, modules/units included in the apparatus or product may be implemented by using hardware such as a circuit. Different modules/units may be located in a same component (for example, a chip or a circuit module) or different components in the terminal device. Alternatively, at least some modules/units may be implemented by using a software program. The software program runs on a processor integrated inside the terminal device, and some remaining (if any) modules/units may be implemented by using hardware such as a circuit.

The examples described above illustrate objectives, technical solutions, and beneficial effects of examples of this disclosure. The above descriptions are examples of this disclosure and are not intended to limit the protection scope of this disclosure. Modifications, equivalent substitutions, improvements, and the like made based on the technical solutions of this disclosure are to fall within the protection scope of this disclosure.

What is claimed is:

1. A data processing method, the method comprising:
obtaining a first dialog sample, the first dialog sample including a first set of words;
determining a first position of the first set of words in a dialog flow, to obtain a flow label of the first set of words; and
determining a second set of words in a library based on the flow label of the first set of words,
when a flow label of the second set of words matches the flow label of the first set of words, fusing the second set of words with the first dialog sample, to obtain a second dialog sample.

2. The method according to claim 1, wherein the determining the first position of the first set of words further comprises:
obtaining a flow label of a third set of words, the third set of words preceding the first set of words in the first dialog sample;
performing intention extraction of the first set of words, to obtain intention information;
determining a plurality of positions in the dialog flow based on the flow label of the third set of words and the intention information;
performing keyword extraction of the first set of words, to obtain a plurality of first keywords;
determining, in the plurality of positions, the first position of the first set of words in the dialog flow based on the plurality of first keywords; and
obtaining the flow label of the first set of words corresponding to the first position in the plurality of positions.

3. The method according to claim 2, wherein the determining the plurality of positions further comprises:
obtaining, in the dialog flow, a second position corresponding to the flow label of the third set of words and a third position after the second position;
determining a similarity between the intention information and an intention corresponding to the third position; and
obtaining the third position that has a similarity greater than or equal to a threshold.

4. The method according to claim 2, wherein the determining, in the plurality of positions, the first position of the first set of words further comprises:
determining the first position having a highest overlap ratio between a keyword group in each of the plurality of positions and the plurality of first keywords.

5. The method according to claim 1, wherein the fusing the second set of words with the first dialog sample further comprises:
concatenating the first set of words and the second set of words, to obtain a fourth set of words; and
concatenating the fourth set of words, a dialog subject in the first dialog sample, and a previous set of words, to obtain the second dialog sample.

6. The method according to claim 5, wherein the concatenating the first set of words and the second set of words further comprises:
masking personal information in the first set of words to obtain a fifth set of words;
masking personal information in the second set of words to obtain a sixth set of words;
determining a first mask ratio of the fifth set of words based on a ratio between a character length of a mask part of the fifth set of words to a character length of the fifth set of words;
determining a second mask ratio of the sixth set of words based on a ratio of a character length of a mask part of the sixth set of words to a character length of the sixth set of words; and
obtaining the fourth set of words based on the first mask ratio, the second mask ratio, the fifth set of words, and the sixth set of words.

7. The method according to claim 6, wherein the obtaining the fourth set of words further comprises:
when the first mask ratio and the second mask ratio are both greater than or equal to a threshold,
concatenating the fifth set of words and the sixth set of words to obtain the fourth set of words; and
when one of the first mask ratio and the second mask ratio is less than the threshold,
performing masking on the fifth set of words to obtain a seventh set of words having a mask ratio that is greater than or equal to the threshold,
performing masking on the sixth set of words to obtain an eighth set of words having a mask ratio that is greater than or equal to the second threshold; and
concatenating the seventh set of words and the eighth set of words to obtain the fourth set of words.

8. A data processing apparatus, the apparatus comprising:
processing circuitry configured to
obtain a first dialog sample including a first set of words;
determine a first position of the first set of words in a dialog flow, to obtain a flow label of the first set of words; and
determine a second set of words in a library based on the flow label of the first set of words,
when a flow label of the second set of words matches the flow label of the first set of words;
fuse the second set of words with the first dialog sample, to obtain a second dialog sample.

9. The apparatus according to claim 8, wherein the processing circuitry is configured to:
obtain a flow label of a third set of words, the third set of words preceding the first set of words in the first dialog sample;
perform intention extraction of the first set of words to obtain intention information;
determine a plurality of positions in the dialog flow based on the flow label of the third set of words and the intention information;
perform keyword extraction of the first set of words to obtain a plurality of first keywords;
determine, in the plurality of positions, the first position of the first set of words in the dialog flow based on the plurality of first keywords; and
obtain the flow label of the first set of words corresponding to the first position in the plurality of positions.

10. The apparatus according to claim 9, wherein the processing circuitry is configured to:
obtain, in the dialog flow, a second position corresponding to the flow label of the third set of words and a third position after the second position;
determine a similarity between the intention information and an intention corresponding to the third position; and
obtain the third position that has a similarity greater than or equal to a threshold.

11. The apparatus according to claim 9, wherein the processing circuitry is configured to:
determine the first position having a highest overlap ratio between a keyword group in each of the plurality of positions and the plurality of first keywords.

12. The apparatus according to claim 8, wherein the processing circuitry is configured to:
concatenate the first set of words and the second set of words to obtain a fourth set of words; and
concatenate the fourth set of words, a dialog subject in the first dialog sample, and a previous set of words, to obtain the second dialog sample.

13. The apparatus according to claim 12, wherein the processing circuitry is configured to:
mask personal information in the first set of words to obtain a fifth set of words;
mask personal information in the second set of words to obtain a sixth set of words;
determine a first mask ratio of the fifth set of words based on a ratio between a character length of a mask part of the fifth set of words to a character length of the fifth set of words;
determine a second mask ratio of the sixth set of words on a ratio of the character length of a mask part of the sixth set of words to a character length of the sixth set of words; and
obtain the fourth set of words based on the first mask ratio, the second mask ratio, the fifth set of words, and the sixth set of words.

14. The apparatus according to claim 13, wherein the processing circuitry is configured to:
when the first mask ratio and the second mask ratio are both greater than or equal to a threshold,
concatenate the fifth set of words and the sixth set of words to obtain the fourth set of words; and
when one of the first mask ratio and the second mask ratio is less than the threshold,
perform mask on the fifth set of words to obtain a seventh set of words having a mask ratio that is greater than or equal to the threshold, and
perform mask on the sixth set of words to obtain an eighth set of words having a mask ratio greater than or equal to the second threshold; and
concatenate the seventh set of words and the eighth set of words to obtain the fourth set of words.

15. A non-transitory computer-readable storage medium, storing instructions which when executed by a processor cause the processor to perform:
obtaining a first dialog sample, the first dialog sample including a first set of words;
determining a first position of the first set of words in a dialog flow, to obtain a flow label of the first set of words; and
determining a second set of words in a library based on the flow label of the first set of words,
when a flow label of the second set of words matches the flow label of the first set of words;
fusing the second set of words with the first dialog sample, to obtain a second dialog sample.

16. The non-transitory computer-readable storage medium according to claim 15, wherein the determining the first position of the first set of words further comprises:
obtaining a flow label of a third set of words, the third set of words preceding the first set of words in the first dialog sample;
performing intention extraction of the first set of words, to obtain intention information;
determining a plurality of positions in the dialog flow based on the flow label of the third set of words and the intention information;
performing keyword extraction of the first set of words, to obtain a plurality of first keywords;
determining, in the plurality of positions, the first position of the first set of words in the dialog flow based on the plurality of first keywords; and
obtaining the flow label of the first set of words corresponding to the first position in the plurality of positions.

17. The non-transitory computer-readable storage medium according to claim 16, wherein the determining the plurality of positions further comprises:
obtaining, in the dialog flow, a second position corresponding to the flow label of the third set of words and a third position after the second position;
determining a similarity between the intention information and an intention corresponding to the third position; and
obtaining the third position that has a similarity greater than or equal to a threshold.

18. The non-transitory computer-readable storage medium according to claim 16, wherein the determining, in the plurality of positions, the first position of the first set of words further comprises:
determining the first position having a highest overlap ratio between a keyword group in each of the plurality of positions and the plurality of first keywords.

19. The non-transitory computer-readable storage medium according to claim 15, wherein the fusing the second set of words with the first dialog sample further comprises:
concatenating the first set of words and the second set of words, to obtain a fourth set of words; and
concatenating the fourth set of words, a dialog subject in the first dialog sample, and a previous set of words, to obtain the second dialog sample.

20. The non-transitory computer-readable storage medium according to claim 19, wherein the concatenating the first set of words and the second set of words further comprises:
masking personal information in the first set of words to obtain a fifth set of words;
masking personal information in the second set of words to obtain a sixth set of words;
determining a first mask ratio of the fifth set of words based on a ratio between a character length of a mask part of the fifth set of words to a character length of the fifth set of words;
determining a second mask ratio of the sixth set of words on a ratio of a character length of a mask part of the sixth set of words to a character length of the sixth set of words; and
obtaining the fourth set of words based on the first mask ratio, the second mask ratio, the fifth set of words, and the sixth set of words.
